(19) United States
(12) Patent Application Publication
(10) Pub. No.: US 2004/0071294 A1
(43) Pub. Date: Apr. 15, 2004

(54) Method and apparatus for automatically configuring surround sound speaker systems

(76) Inventors: Joseph F. Halgas JR., Huntingdon Valley, PA (US); Christopher J. Stone, Newtown, PA (US)

Correspondence Address: STEVEN L. NICHOLS, RADER, FISHMAN & GRAVER PLLC, 10653 S. RIVER FRONT PARKWAY, SUITE 150, SOUTH JORDAN, UT, 84095, US

(21) Appl. No.: 10/271,021

(22) Filed: Oct. 15, 2002

(51) Int. Cl. H04R 29/00; H04B 5/00

(52) U.S. Cl. 381/59; 381/58; 381/79

(57) ABSTRACT

The present invention provides a method for automatically configuring a speaker system. The method includes the steps of placing a radio frequency identification (RFID) tag on a speaker of the above mentioned speaker system, placing a wireless communication device in a location representing the most likely location of the listener, determining the distance from the device location to the speaker using the RFID tag and said wireless communication device, and transmitting the determined distance from location representing the most likely location of the listener to the speaker to the speaker system controller.

### TECHNICAL FIELD

The present invention relates to audio data transmission. Specifically, the present invention relates to a method and apparatus for automatically configuring a surround sound speaker system.

### BACKGROUND OF THE INVENTION

Home theater systems include audio/video (A/V) receivers. A/V receivers are specialized to handle the multiple channels required to produce a theater-like surround sound effect. Most receivers being sold on the market are capable of providing analog based Dolby Pro Logic™ surround sound or the digitally based Dolby Digital™. Consumers with relatively old receivers that do not have surround sound capabilities have to purchase an additional component to attach to their existing receiver to upgrade to Dolby Pro Logic™. Similarly, consumers owning an existing receiver with or without Dolby Pro Logic™ capabilities need to purchase an additional component to upgrade to Dolby Digital™.

A traditional home-theater system (100) is illustrated in FIG. 1. As shown in FIG. 1, a traditional home-theater system (100) includes an A/V receiver (150) to which a number of audio and video components may be attached. These components may include a videocassette recorder (VCR) (130), a digital video disc (DVD) player (140), a television (110) (e.g., a high-definition or a digital television), a compact disc (CD) player (120), a tape deck, a tuner, a phonograph, an auxiliary amplifier, and/or an upgrade component in order to provide surround sound. As for outputs, which are typically connected to loudspeakers, conventional A/V receivers (150) have two main or front channels (right (160) and left (185)) as well as a number of surround sound channels, including rear right (165) and rear left (165) channels, a center channel (170), and a sub-woofer (175). If a user is listening to the radio, the A/V receiver (150) typically provides audio output on the front right (160) and front left (185) channels only. If the user switches to an input with surround sound capabilities, such as a DVD player (140) or a surround sound broadcast, the A/V receiver (150) provides audio output on the surround sound channels in addition to the front right (160) and front left (185) channels.

One of the difficulties associated with installing a home-theater system is matching the existing A/V receiver (150) with the surround sound components. For example, if a user is listening to an audio signal from a tuner and adjusts the volume (of the front channel speakers (160, 185)) to a comfortable listening level and then switches to a digital surround sound signal from a DVD player (140), the level of the audio signal provided to the front channel speakers (160, 185) may be disproportionately higher (or lower) than the level of the digital audio signal provided to the surround sound speakers (165, 170, 175, 180). The resulting surround sound effect will not be balanced or harmonious. Additionally, while surround sound systems may be configured to provide ideal sound to a specific area, listener locations often change. To compensate for this disproportionality, a traditional user would have to manually adjust or align the volume control of the A/V receiver (150) with the surround sound components in order to balance the levels of the multiple surround sound speakers (165, 170, 175, 180) with the levels of the front channels (160, 185). This balance of the surround sound speakers (165, 170, 175, 180) is often an inexact science in that the user goes by ear, or by what sounds good to him or her at a specific location with respect to the speakers while adjusting the volume level of each speaker. After adjusting the volume of the A/V receiver (150), the user will adjust the volume of the surround sound environment (including the front right (160) and left (185) channels).

Recent speaker configuration systems allow for an automatic configuration of a speaker system by focusing on the volume of each speaker as disclosed in U.S. Pat. No. 6,026,168 (incorporated herein by reference in its entirety). A small microphone unit held by the user measures volume at a listening position as each speaker plays a test tone. The overall volume is then adjusted accordingly. However, speaker distance and speaker size still need to be determined and entered manually by the user. Traditionally, users had to measure the distance between their listening position and each speaker, navigate through the receiver's various menus, and enter the data manually. In addition, many high-end audio systems require the user to adjust the individual volume of each speaker and select the “size” of each speaker based on its physical dimensions, power handling capability, and frequency response. This traditional method results in a less-than-ideal sound from the surround sound system.

### SUMMARY OF THE INVENTION

In one of many possible embodiments, the present invention provides a method for configuring a speaker system. The method includes placing a radio frequency identification (RFID) tag on a speaker of the above mentioned speaker system, placing a wireless communication device in a location representing the most likely location of the listener, determining the distance from the device location to the speaker using the unique properties of the RFID tag and the wireless communication device, and transmitting to the speaker system controller the determined distance of the speaker.

Another embodiment of the present invention provides an apparatus for automatically configuring a speaker system. The apparatus includes a system controller, a plurality of speakers communicatively coupled to the system controller, and an RFID tag affixed to each of the speakers, each RFID tag comprising a resonating frequency. Additionally, the apparatus includes a wireless communication device, which is communicatively coupled to both the system controller and the RFID tags. The wireless communication device is capable of determining the relative positions of speakers in the speaker system by both transmitting and receiving RF signals.

### BRIEF DESCRIPTION OF THE DRAWINGS

The accompanying drawings illustrate various embodiments of the present invention and are a part of the specification. Together with the following description, the drawings demonstrate and explain the principles of the present invention. The illustration embodiments are examples of the present invention and do not limit the scope of the invention.

FIG. 1 illustrates a traditional surround sound home entertainment system.

FIG. 2 demonstrates the components of a surround sound home entertainment system according to one embodiment of the present invention.

FIG. 3 is a simplistic block diagram illustrating the components of a wireless communication device according to one embodiment of the present invention.

FIG. 4 is a block diagram illustrating an automatic configuration method according to one embodiment of the present invention.

FIG. 5 is a flow chart demonstrating a method for determining speaker distance according to one embodiment of the present invention.

FIG. 6 is a flow chart illustrating a method for tone adjustment according to one embodiment of the present invention.

FIG. 7 illustrates RFID tag frequencies according to one embodiment of the present invention.

FIG. 8 illustrates a location request by a wireless communication device according to one embodiment of the present invention.

Throughout the drawings, identical reference numbers designate similar, but not necessarily identical, elements.

### DETAILED DESCRIPTION OF THE PREFERRED EMBODIMENTS

Embodiments of the invention are generally drawn to a method for automatically configuring a surround sound system. According to one exemplary implementation, described more fully below, an innovative method for configuring a surround sound system to perform at a substantially optimal level at a user location is presented. In the following description, for purposes of explanation, numerous specific details are set forth in order to provide a thorough understanding of the invention. It will be apparent, however, to one skilled in the art that the invention can be practiced without these specific details.

Reference in the specification to “one embodiment” or “an embodiment” means that a particular feature, structure, or characteristic described in connection with the embodiment is included in at least one embodiment of the invention. The appearance of the phrase “in one embodiment” in various places in the specification are not necessarily all referring to the same embodiment.

For ease of explanation only, the following description will be developed within the context of a digital convergence platform (DCP) device. However, the present invention may be performed in association with any surround sound receiver capable of independent control of speaker volume and/or delay.

### Exemplary Overall Structure

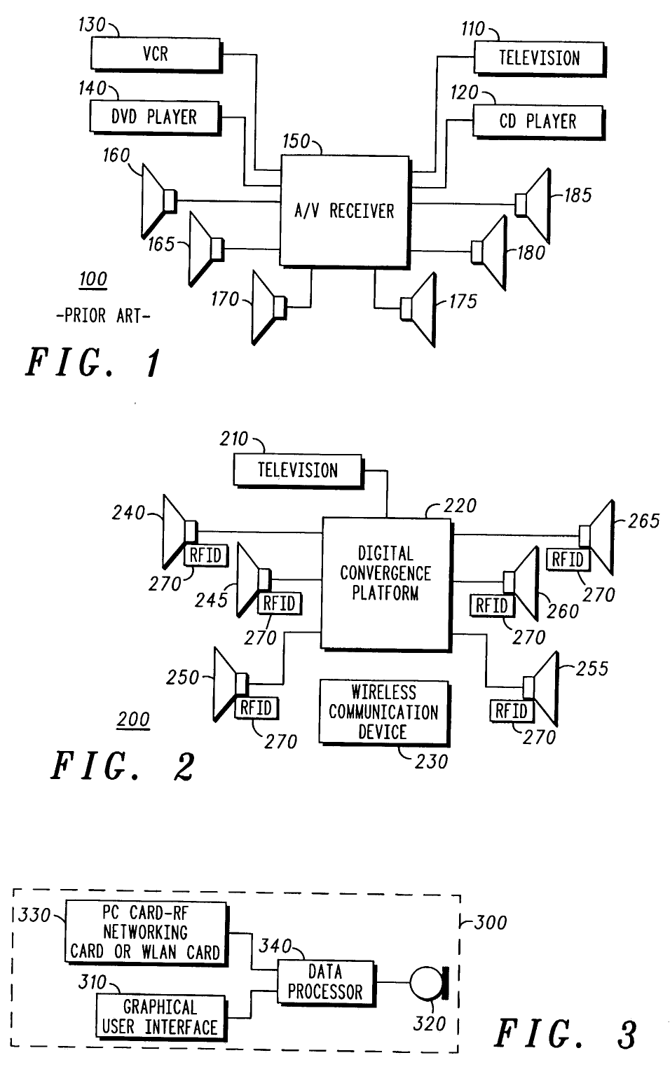

FIG. 2 illustrates one embodiment of a surround sound entertainment system according to the present invention. As demonstrated in FIG. 2, a surround sound system according to the present invention includes a television (21 0) communicatively connected to a digital convergence platform (DCP) (220). Leading out from the DCP (220), are a number of speakers. As shown in FIG. 2, there are preferably six speakers communicatively connected to the DCP (220). These speakers include a front right (240) and a front left speaker (265) to allow for stereo sound. In order to complete the surround sound configuration, a right (245) and a left surround sound speaker (260) are also connected to the DCP (220) along with a center channel speaker (250) and a sub-woofer (255). Attached to each speaker is a radio frequency identification (RFID) tag (270). As shown in FIG. 2, the sub-woofer (255) does not require an RFID tag (270). An RFID tag (270) is not required on the sub-woofer because the sub-woofer (255) produces omni-directional bass frequencies that do not require gain or delay tuning by the DCP (220). A wireless communication device (230) is also a component of the surround sound system according to one embodiment of the present invention.

The DCP (226) of the present system is intended to be the center of a user's home theater system. The DCP (220) is preferably an all-in-one digital cable box, AM/FM tuner, DVD player, and audio amplifier intended to provide users with an integrated home theater system inside a single chassis. The DCP (220) preferably includes the latest technologies, including digital audio decoders, multi-format audio support, digital signal processing (DSP) audio modes, programmable infrared (IR) and radio frequency (RF) remote controls, and support for the speaker configuration and optimization. As a result, the DCP (220) has many configurable options that are accessed through plain text-based on screen displays (OSDs). Several of the DCP's OSDs relate to speaker size, volume, and distance from the listener. These OSDs can be confusing to the average user, difficult to navigate, difficult to configure properly, and may result in a less-than-optimal listening environment. Given the emphasis on clarity and performance placed on home theater systems today, the present invention ensures that the user is always enjoying the best possible sound reception without difficult configuration requirements.

The RFID Tags (270) shown in FIG. 2 incorporate radio frequency identification technology. Radio frequency identification (RFID) is a technology that uses electromagnetic or electrostatic coupling in the radio frequency portion of the electromagnetic spectrum to uniquely identify an object, animal, or person. One advantage of RFID is that it does not require direct contact or line-of-sight scanning. A typical RFID system consists of three components: an antenna, a transceiver, and a transponder.

The RFID tags (270) form the transponder portion of the present invention. The RFID tags (270) are small passive electronic circuits that are designed to resonate at specific RF frequencies. When the tags are excited by RF waves of the resonance frequency, they emit RF signals of their own. A receiver then receives this RF signal and is able to use the received signal to perform a number of calculations. Since the RFID tags (270) are passive devices, they require no power source of their own to operate and are powered by the incoming RF waves from the transmitter. Since RFID tags (270) can be designed to operate at a specific frequency, many different RFID tags (270) can be used in close proximity without any interference between them.

The RFID tags (270) of the present invention are preferably simple peel-and-stick labels with passive circuitry embedded on the label. These self-adhesive labels may be applied to the speaker cabinet wherever the user wishes. Preferably, the RFID labels (270) are applied to the front of the speaker so that they more accurately represent the distance of the speaker's sound waves point of origin to the user. However, since this approach is not aesthetically pleasing, the RFID labels (270) may be applied to the rear or bottom of the speaker cabinet so that they are out of sight. Each label is printed with the speaker for which it is intended: left, right, center, left surround and right surround. Each RFID tag corresponds to an individual speaker within the surround sound system. In this embodiment, there are 5 RFID tag channels (corresponding to a Dolby Digital 5.1™ or Consumer DTS system), however, this number can be expanded or contracted according to individual system needs. Within minutes, a user can convert any speaker group into a system compatible with the present invention that can be configured and optimized automatically for use with the DCP unit (220).

The wireless communication device (300) shown in FIG. 3 aids in the configuration of the surround sound speakers. FIG. 3 illustrates the major components of the wireless communication device (300). As shown in FIG. 3, the wireless communication device (300) contains a personal computer (PC) card (330) communicatively connected to a data processor (340). The PC card (330) is preferably a wireless RF networking card or a WLAN card. The RF networking protocol may be one of many available wireless technologies, which consist of but is not limited to 802.11a, 802.11b (a.k.a. Wi-Fi), HomeRF, BlueTooth, 802.15.3 (a.k.a. WPAN), etc. The PC card (330), using firmware modifications, doubles as a transmitter and receiver for the speaker RFID tags (270). Alternatively, the components that constitute the RF networking card may also be embedded within the wireless communication device. The wireless communication device is also loaded with a graphical user interface (GUI) (310) application that walks users through several steps to optimizing a surround sound system. The wireless communication device illustrated in FIG. 3 also contains a built-in microphone (320), which is used to analyze each speaker's relative volume so that the proper adjustments can be made to improve the sound at the location of the wireless communication device (300). As shown in FIG. 3, both the graphical user interface (310) and the microphone (320) are communicatively coupled to the data processor (340).

Preferably, the wireless communication device (300) of FIG. 3 is the Motorola Evr-8401 enhanced TV viewer. However, the present invention may be practiced using any device that contains a transceiver and an antenna capable of bi-directional wireless communication.

### Exemplary Implementation and Operation

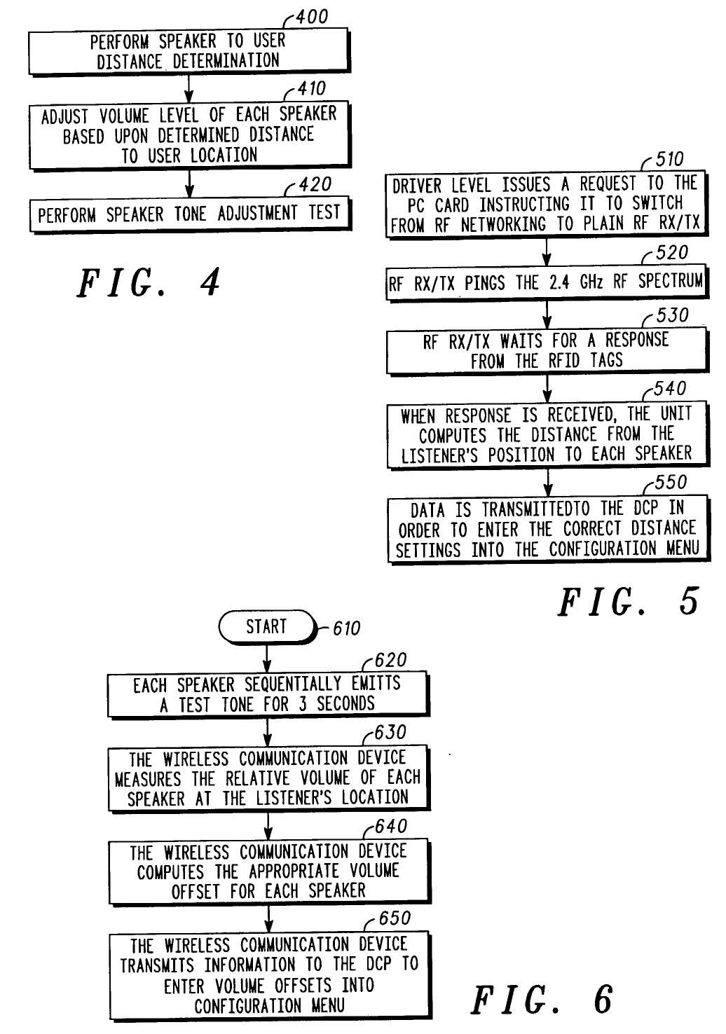

FIG. 4 illustrates an automatic configuration method according to one embodiment of the present invention. Implementation and operation of the present invention may begin once a surround sound configuration has been connected to the DCP (220). As shown in FIG. 4, the automatic configuration method begins with the wireless communication device (230) performing a speaker to user distance determination (400). Once the distance from the user to each speaker has been determined, the information is relayed to the DCP (220) and entered into the configuration menu. When the distance of each speaker from the wireless communication device (230) is entered into the configuration menu, the DCP (220) adjusts the volume level and the delay period of each speaker based, at least in part, on the previously mentioned speaker distance determination. The theory and practice of delaying the audio signals that are delivered to the amplifiers of the individual speaker is well known to those in the art. When the speaker volumes and delay periods have been adjusted accordingly, the DCP (220) performs a speaker tone adjustment test (420) with the aid of the wireless communication device (230).

The initial step in configuring a home theater system is to determine the distance from the listener to the speakers. The distance determination is performed in order to adjust delay times and volume levels for each speaker so that the signals from each speaker arrive at the listener's ear simultaneously and proportionately, thereby improving the surround sound effect.

FIG. 5 illustrates a method for performing a distance determination according to one embodiment of the present invention. Upon setup of the surround sound system within the consumer's home, the consumer places the wireless communication device (300) in the location within the room where the consumer expects to be seated while viewing surround sound programs. The wireless communication device (300) then initiates a simple communication sequence with each RFID tag (270). As shown in FIG. 5, when the user opts to utilize the wireless communication device (300) as a means to calibrate the surround sound system, the driver level of the wireless communication device issues a request to the PC card (330) and instructs the PC card to switch modes from radio frequency (RF) networking to plain radio frequency receiver transmitter mode (RF RX/TX) (510). This switch from RF networking to plain radio frequency receiver transmitter mode (RF RX/TX) (510) allows the wireless communication device (300) to act as an RF transceiver. When the PC card (330) of the wireless communication device (300) is in the RF RX/TX mode, the RF RX/TX pings the 2.4 GHz RF spectrum associated with the RFID tags (520) and waits for a response from each of the RFID tags (530). While the present embodiment pings the 2.4 GHz RF spectrum, pinging any number of RF spectrums, including the FCC designated unlicensed national information infrastructure (U-NII) bands (5.15-5.35 GHz and 5.725-5.825 GHz), the unlicensed industrial scientific and medical (ISM) bands (902-928 MHz and 2400-2483.5 MHz), or any other authorized frequency band is within the scope of the present invention.

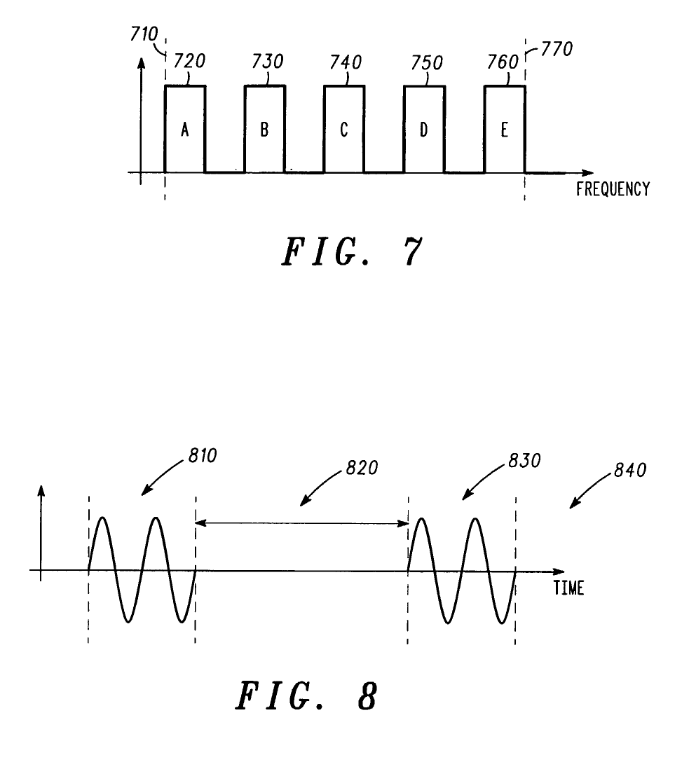

As shown in FIG. 7, the RF RX/TX selectively pings frequencies within the 2.4 GHz RF spectrum (520). Each RFID tag (270) is designed to respond to a particular transmission frequency from the RF RX/TX of the wireless communication device (230) within the 2.4 GHz spectrum. At its particular transmission frequency, each RFID tag will return a portion of the transmitted energy back to the RF RX/TX of the wireless communication device. As illustrated in FIG. 7, according to one embodiment of the present invention, the RFID tags corresponding to each of the surround sound speakers are such that they have sequentially ordered resonant frequencies (720-760), all contained within the 2.4 GHz spectrum. In this embodiment, the RF RX/TX oft he wireless communication device may begin its pinging of the 2.4 GHz spectrum at a band start frequency (710) that is lower that any resonance frequency of the RFID tags, and end at a band stop frequency (770) that is at least equal to the resonance frequency of the RFID tag with the highest resonance frequency. In this manner, the wireless communication device (230) is assured to have pinged the resonant frequency of each speaker in the surround sound system. When each individual RFID tag receives a signal corresponding to its resonant frequency, the RFID tag will resonate a portion of the signal back to the wireless communication device. The wireless communication device is able to determine which RFID tag is returning a signal due to the distinct frequency assigned to each RFID tag. The RFID tag will ignore all transmitted frequencies not equal to the resonant frequency.

FIG. 8 illustrates the sequential process the wireless communication device goes through in selectively determining the distance of each speaker in the surround sound system. The wireless communication device begins pinging the RF frequency at a start band frequency (710) corresponding to the lowest frequency attributed to one of the RFID tags. Once the burst of RF energy is transmitted (810), the RF RX/TX of the wireless communication device waits for a return signal from the corresponding RFID tag. The specified amount of time the RF RX/TX of the wireless communication device waits to receive a response from the RFID tag once it has called the RFID tag is known as a receive interval (820). Once the RF RX/TX has waited for the entire receive interval (820), the RF RX/TX of the wireless communication device then calls to the next RFID tag as shown in FIG. 8 (830). This communication process continues until the transceiver reaches a band stop frequency (770) corresponding to an upper limit, beyond which there is no RFID tag corresponding to the frequency. Once the band stop frequency (770) is reached, the process is ready to begin again.

Referring again to FIG. 5, when a return signal has been received from an RFID tag, the wireless communication device computes the distance from the listener's position to each speaker (540). When an energy burst strikes an RFID tag, if the energy burst corresponds to the resonance frequency of that RFID tag, a portion of that energy is reflected back to the antenna. Both the energy burst and the energy reflected by the RFID tag travel at the speed of light. When the wireless communication device (230) acting as an antenna receives the reflected RF energy, it records the amount of time that elapsed between the transmission of the energy burst and the reception of the reflected signal. The distance from the wireless communication device (230) to the RFID tag can then be computed using the elapsed time between transmission and reception of the signal scaled by the speed of light.

When the distance from the wireless communication device to each RFID tag has been computed (540), the wireless communication device transmits the relative speaker distance data to the DCP (220) using the wireless technology of the PC card (330). When the DCP (220) receives the speaker distance data, that data is entered into the configuration menu (550).

When the DCP (220) receives the relative speaker distance data and the data is entered into the configuration menu, the distance data can then be used to adjust both the individual speaker volume and the signal delay of each speaker (410). When all the distances are entered into the configuration menu of the DCP (220), firmware within the DCP (220) adjusts the individual volume of each speaker, based at least in part on the relative distance of the speaker. The volume adjustment is made to assure that the intensity level from each speaker is the same when it arrives at the location of the wireless communication device (230). In a similar fashion, the DCP (220) is able to adjust the signal delay for each speaker to assure that signals intended to arrive at the location of the wireless communication device (230) simultaneously will accomplish just that. According to one embodiment of the present invention, the signal delay time for each speaker is calculated based upon the distance from each speaker to the wireless communication device (230). Once the distance from the wireless communication device (230) to each speaker is entered into the DCP's configuration menu, the DCP (220) calculates the delay time required for each speaker and adjusts the signal delay to each speaker accordingly.

When the initial volume levels and signal delay times are set, the DCP performs a speaker tone adjustment test (420). The speaker tone adjustment test is illustrated in FIG. 6. As shown in FIG. 6, the wireless communication device instructs the DCP to enter the test tone adjustment mode (610) and causes each speaker to selectively emit a test tone for 3 seconds (620). The wireless communication device measures the relative volume of each speaker at the device's location (630), and then computes the appropriate volume offsets (up or down) for each speaker (640). This data is then transmitted to the DCP and entered into its configuration menu (650) where the appropriate volume offsets are applied.

As illustrated in FIG. 6, the test tone adjustment process begins by each speaker sequentially emitting a test tone for 3 seconds (620). Emitting test tones of any designated period of time is within the scope of the present invention. Each speaker emits the test tone in turn; thereby allowing the wireless communication device to know which tone corresponds to which speaker. The test tone may be either a constant pitch tone that is pre-programmed in the DCP or a sound sample representative of the program being played by the DCP. As the test tone is emitted, the wireless communication device is able to both receive (630) and analyze (640) the sequential tones.

As the tones are emitted, the internal microphone associated with the wireless communication device is able to receive and measure the relative volume intensity of each speaker associated with the surround sound system (630). By placing the wireless communication device in the most likely spot for the consumer to be listening to the surround sound system, the relative volume adjustment and signal delay can be determined and optimized for that position.

Once the sequential test tones have been emitted and measured by the wireless communications device, the wireless communication device is able to compute the appropriate volume offset for each speaker (640). The data processor receives data concerning both the tone intensity and time delay associated with each speaker. The wireless communication device (300) also receives information from the DCP (202) regarding the current volume levels of each speaker. The data processor (340) of the wireless communication device (300) then computes the appropriate speaker volume offset and delay for each speaker based, at least in part, on the data received by the internal microphone (320).

When the volume offset and delay have been computed for each speaker in the surround sound system, the wireless communication device transmits the volume and offset information to the DCP. The DCP enters the information into the configuration menu and then adjusts the amplifier settings in order to maintain an even listening volume across the room.

This configuration and optimization process can be repeated as many times as desired. Repetitions of the configuration and optimization process will likely occur if a new listening position is chosen. Additionally, the user always has the ability to override the present invention and enter their own values into the DCP OSD menus at any time.

### Alternative Embodiment

In an alternative embodiment, the RFID tags (270) shown in FIG. 2 may be active, rather than passive components. According to this embodiment, the active RFID tags (270) continually radiate time stamped packets and/or packets at designated intervals. The time stamped packets and/or packets sent at designated intervals are then received and captured by the wireless communication device (230). When the wireless communication device (230) captures the time stamped packets and/or packets sent at designated intervals, the wireless communication device (230) measures the time between the packets and determines the distance from each speaker to the wireless communication device (230) based on the time measurements.

Additionally, the RFID tags (270) may be RF networking compliant. According to this embodiment, the RFID tags (270) utilize a protocol (e.g. 802.11b) in conjunction with the wireless communication device (230). With the RFID tags (270) utilizing a wireless communication protocol, the wireless communication device (270) does not have to switch modes from radio frequency (RF) networking to plain radio frequency receiver transmitter mode (RF RX/TX)). Rather, this alternative embodiment of the present invention would utilize the properties of an active RFID tag to determine the distance from the wireless communication device (230) to each speaker as described above.

In conclusion, the present invention, it its various embodiments, allows for the use of RFID tags for automatically configuring and optimizing the speaker levels of a surround sound system. Specifically, the present invention allows RFID tags to be used to determine the relative location of surround sound speakers. By allowing for the use of RFID tags to determine the relative location of surround sound speakers, volume adjustments and signal delays can be automatically calculated to optimize the listening experience at specific locations. Additionally, embodiments of the present invention will simultaneously reduce the complexity and user input required for the configuration of traditional surround sound systems.

The preceding description has been presented only to illustrate and describe the invention. It is not intended to be exhaustive or to limit the invention to any precise form disclosed. Many modifications and variations are possible in light of the above teaching.

The preferred embodiment was chosen and described in order to best illustrate the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A method for configuring a speaker system comprising:
placing a radio frequency identification (RFID) tag on a speaker of said speaker system;
placing a wireless communication device in a specified location;
determining the distance from said specified location to said speaker using said RFID tag and said wireless communication device; and
transmitting said determined distance from said specified location to said speaker to a controller of said speaker system.

2. A method for configuring a speaker system according to claim 1, wherein determining the distance from said specified location to said speaker comprises:
pinging a radio frequency (RF) spectrum with said wireless communication device at a frequency corresponding to a resonance frequency of said RFID tag;
receiving said RF signal in said RFID tag;
resonating a return signal from said RFID tag to said wireless communication device;
receiving said return signal from said RFID tag in said wireless communication device;
determining the time lapse between sending said frequency ping and receiving said return signal; and
determining the distance from said specified location to said speaker based upon said determined time lapse.

3. A method for configuring a speaker system according to claim 2, wherein said RFID tag comprises a passive RFID tag.

4. A method for configuring a speaker system according to claim 3, wherein said wireless communication device further comprises an RF networking card, a graphical user interface (GUI), and a microphone.

5. A method for configuring a speaker system according to claim 4, wherein said controller of said speaker system stores said determined distance in a configuration menu.

6. A method for configuring a speaker system according to claim 2, further comprising adjusting the volume of said speaker based on said determined distance.

7. A method for configuring a speaker system according to claim 6, wherein said speaker system comprises a surround sound speaker system.

8. A method for configuring a speaker system according to claim 7, further comprising:
placing an RFID tag on each speaker in said surround sound system;
determining the distance from said specified location to each speaker in said surround sound system using said RFID tags and said wireless communication device; and
adjusting the signal delay time of each of said speakers in said surround sound system to allow simultaneously produced signals to reach said specified location simultaneously.

9. A method for configuring a speaker system according to claim 8, wherein said determining the distance from said specified location to each speaker in said surround sound system using said RFID tags and said wireless communication device further comprises:
pinging said RF spectrum at first lowest resonating frequency of all of said RFID tags located on said speakers;
waiting for a predetermined period of time for a return signal from said RFID tag;
sequentially pinging resonating frequency of each of said RFID tags located on said speakers; and
waiting for said predetermined period of time for a return signal between each of said sequential pings.

10. A method for configuring a speaker system according to claim 8, wherein said configuration occurs automatically upon connection of said surround sound system to said speaker system controller.

11. A method for configuring a speaker system according to claim 8, wherein the volume of each of said speakers in said surround sound system is independently adjusted based upon said determined distance from said specified location to each speaker in said surround sound system.

12. A method for configuring a speaker system according to claim 11, further comprising performing a speaker tone adjustment test.

13. A method for configuring a speaker system according to claim 12, wherein said speaker tone adjustment test comprises:
sequentially emitting a test tone from each of said speakers;
measuring said test tone at said specified location using said wireless communication device;
computing appropriate volume offset for each of said speakers based on said test tone measurement; and
transmitting said volume offsets to said speaker system controller.

14. A method for configuring a speaker system according to claim 1, wherein said RFID tag comprises an active RFID tag.

15. A method for configuring a speaker system according to claim 14, wherein said determining the distance from said specified location to said speaker using said RFID tag and said wireless communication device comprises:
emitting a packet from said active RFID tag at a designated interval;
receiving said packet at said wireless communication device; and
calculating said distance from said specified location to said speaker using said received packet.

16. A method for determining the relative location of speakers in a surround sound system comprising:
placing an RFID tag on each speaker in said surround sound system;
placing a wireless communication device in a specified location;
sequentially pinging a RF spectrum with said wireless communication device at frequencies corresponding to resonance frequencies of said RFID tags;
sequentially receiving said RF signal in said RFID tags;
resonating a return signal from each of said RFID tags to said wireless communication device when frequency corresponding to resonance frequency of said RFID tag is received;
receiving said return signal from each of said RFID tags in said wireless communication device;
determining the time lapse between sending said frequency ping and receiving said return signal; and
calculating the distance from said specified location to said speakers based upon said determined time lapses.

17. A method for determining the relative location of speakers in a surround sound system according to claim 16, wherein said RF spectrum comprises the 2.4 GHz RF spectrum.

18. A method for determining the relative location of speakers in a surround sound system according to claim 17, further comprising:
adjusting the signal delay time of each of said speakers in said surround sound system based on said determined distance to allow simultaneously produced signals to reach said specified location simultaneously; and
independently adjusting the volume of each of said speakers in said surround sound system based on said determined distance.

19. A method for determining the relative location of speakers in a surround sound system according to claim 18, wherein said distance determination and said volume and delay time adjustments occur automatically upon receiving a single request by said wireless communication device in the controller of said surround sound speaker system.

20. An apparatus for automatically configuring a speaker system comprising:
a system controller;
a plurality of speakers communicatively coupled to said system controller;
an RFID tag affixed to each of said speakers, wherein said RFID tag includes a resonating frequency; and
a wireless communication device communicatively coupled to said system controller and said RFID tags capable of determining relative positions of said speakers by both transmitting and receiving RF signals.

21. An apparatus for automatically configuring a speaker system according to claim 18, wherein said plurality of speakers comprises a surround sound system.

22. An apparatus according to claim 21, wherein said wireless communication device further comprises:
a wireless personal computer (PC) card capable of communicating with both RFID tags and said system controller;
a microphone;
a graphical user interface (GUI); and
a data processor communicatively coupled to said wireless PC card, said microphone, and said GUI to analyze received data and to control said PC card.

23. An apparatus for automatically configuring a speaker system according to claim 22, wherein determining relative positions of speakers comprises:
pinging a radio frequency (RF) spectrum with said wireless communication device at a frequency corresponding to a resonance frequency of said RFID tag;
receiving said RF signal in said RFID tag;
resonating a return signal from said RFID tag to said wireless communication device;
receiving said return signal from said RFID tag in said wireless communication device;
determining the time lapse between sending said frequency ping and receiving said return signal; and
calculating the distance from said specified location to said speaker based upon said determined time lapse.

24. An apparatus for automatically configuring a speaker system according to claim 23, wherein said RFID tag comprises a passive RFID tag.

25. An apparatus for automatically configuring a speaker system according to claim 23, wherein said system controller adjusts speaker volume or signal delay time based on said distance calculation.

26. An apparatus for automatically configuring a speaker system according to claim 25, wherein said distance determination and said volume and delay time adjustments occur automatically upon receiving a single request by said wireless communication device in said controller of said surround sound speaker system.

27. An apparatus for automatically configuring a speaker system according to claim 25, wherein said controller performs a speaker tone adjustment test upon completion of said volume and signal delay time adjustments.

28. An apparatus for automatically configuring a speaker system according to claim 27, wherein said speaker tone adjustment test comprises:
sequentially emitting a test tone from each of said speakers;
measuring said test tone at a specified location using said wireless communication device;
computing appropriate volume offset for each of said speakers based on said test tone measurement; and
transmitting said volume offsets to said speaker system controller.

29. An apparatus for automatically configuring a speaker system comprising:
a controlling means for controlling said speaker system;
a speaker communicatively coupled to said controlling means;
an RF signal transponding means for receiving an RF signal and transponding said RF signal back to a source of said RF signal, said RF transponding means being substantially attached to said of speaker; and
a communications means for remotely communicating with said signal transponding means and said controlling means, wherein said communications means is capable of determining relative position of said speaker by both transmitting and receiving RF signals.

30. An apparatus for automatically configuring a speaker system according to claim 29, wherein said RF signal transponding means comprises an RFID tag.

31. An apparatus for automatically configuring a speaker system according to claim 30, wherein said RFID tag further comprises a passive RFID tag.

32. An apparatus for automatically configuring a speaker system according to claim 29, wherein said communications means further comprises an RF networking card, a graphical user interface (GUI), and a microphone.

33. An apparatus for automatically configuring a speaker system according to claim 32, wherein determining relative position of said speaker comprises:
pinging a radio frequency (RF) spectrum with said communications means at a frequency corresponding to a resonance frequency of said RFID tag;
receiving said RF signal in said RFID tag;
resonating a return signal from said RFID tag to said communications means;
receiving said return signal from said RFID tag in said communication means;
determining the time lapse between sending said frequency ping and receiving said return signal; and
calculating the distance from said communication means to said speaker based upon said determined time lapse.

34. An apparatus for automatically configuring a speaker system according to claim 33, wherein said automatic configuration further comprises:
transmitting said calculated distance from said communication means to said controlling means;
and adjusting said speaker volume and said signal delay time based upon said calculated distance.

35. An apparatus for automatically configuring a speaker system containing firmware stored in a memory unit, which when executed causes said device to:
ping a radio frequency (RF) spectrum at a frequency corresponding to a resonance frequency of a RFID tag located on a speaker of said speaker system using a wireless communication device;
receive said RF signal in said RFID tag;
resonate a return signal from said RFID tag to said wireless communication device;
receive said return signal from said RFID tag in said wireless communication device;
determine the time lapse between sending said frequency ping and receiving said return signal; and
calculate the distance from said specified location to said speaker based upon said determined time lapse.
